(19) United States
(12) Patent Application Publication
(10) Pub. No.: US 2025/0326312 A1
(43) Pub. Date: Oct. 23, 2025

(54) DEVICE AND SYSTEM FOR CONTROLLING CHARGING VOLTAGE USING CIRCULATING CURRENT

(71) Applicant: HL MANDO CORPORATION, Gyeonggi-do (KR)

(72) Inventors: Bong Yeon CHOI, Gyeonggi-do (KR); Sung Hyun LIM, Gyeonggi-do (KR)

(21) Appl. No.: 18/919,409

(22) Filed: Oct. 17, 2024

(30) Foreign Application Priority Data
Apr. 17, 2024 (KR) 10-2024-0051385

(51) Int. Cl. B60L 53/62; H02J 7/06; H02M 1/42; H02M 3/335

(52) U.S. Cl. CPC B60L 53/62; H02J 7/06; H02M 1/4216; B60L 2210/10; B60L 2210/30; H02J 2207/20; H02M 3/33573; H02M 3/33576

(57) ABSTRACT

The disclosure relates to a technology for controlling charging current using a circulating current and provides a charging voltage control device and system controlling a circulating current and comprising a power factor correction circuit converting a multi-phase alternating current (AC) voltage into a direct current (DC) voltage based on an operation of switching elements, a relay including at least one switch connected to the power factor correction circuit to control a current applied to each phase and a neutral line, a link capacitor to which a DC voltage converted by the power factor correction circuit is applied, and a controller generating circulating currents by controlling the operation of switching elements and the at least one switch when the link capacitor is required to be discharged and controlling circulation directions of the circulating currents to discharge the DC voltage through power generated based on the circulation directions of the circulating currents.

### CROSS-REFERENCE TO RELATED APPLICATION

This application claims priority from Korean Patent Application No. 10-2024-0051385, filed on Apr. 17, 2024, which is hereby incorporated by reference for all purposes as if fully set forth herein.

### BACKGROUND

### Field

The disclosure relates to a technique for controlling charging voltage using circulating current.

### Description of Related Art

Electric energy is gaining attention as an eco-friendly fuel for vehicles. The energy efficiency of an electric vehicle is determined by the efficiency of charging and discharging electric energy.

Additionally, the battery charging system installed in electric vehicles generates high voltage internally when in operation, which may increase the risk of fire in the event of a collision or mechanical failure. Therefore, for user safety, an operation should be perform to discharge the internal voltage. Typically, battery charging systems are configured to perform forced discharge by installing an additional discharge circuit.

However, fast discharge is possible by installing an additional circuit for forced discharge, but the system size and cost increase.

### BRIEF SUMMARY

The disclosure provides a technique for controlling charging voltage using circulating current.

In an aspect, the present embodiments provide a charging voltage control device controlling a circulating current of a charger and comprising a power factor correction circuit converting a multi-phase alternating current (AC) voltage into a direct current (DC) voltage based on an operation of a plurality of switching elements, a relay including at least one switch connected to the power factor correction circuit to control a current applied to each phase and a neutral line, a link capacitor to which a DC voltage converted by the power factor correction circuit is applied, and a controller generating two or more circulating currents by controlling the operation of the plurality of switching elements and the at least one switch when the link capacitor is required to be discharged and controlling circulation directions of the two or more circulating currents to discharge the DC voltage through power generated based on the circulation directions of the two or more circulating currents.

In another aspect, the present embodiments provide a charging voltage control system controlling a charging voltage using a circulating current of a charger and comprising at least one battery configured in a vehicle and a vehicle charging voltage control device for charging the battery, wherein the vehicle charging voltage control device includes a power factor correction circuit converting a multi-phase AC voltage into a DC voltage based on an operation of a plurality of switching elements, a relay including at least one switch connected to the power factor correction circuit to control a current applied to each phase and a neutral line, a link capacitor to which a DC voltage converted by the power factor correction circuit is applied, and a controller generating two or more circulating currents by controlling the operation of the plurality of switching elements and the at least one switch when the link capacitor is required to be discharged and controlling circulation directions of the two or more circulating currents to discharge the DC voltage through power generated based on the circulation directions of the two or more circulating currents.

The disclosure may provide a technique for controlling charging voltage using circulating current.

### DESCRIPTION OF DRAWINGS

The above and other objects, features, and advantages of the disclosure will be more clearly understood from the following detailed description, taken in conjunction with the accompanying drawings, in which:

FIG. 1 is a view illustrating a configuration of a device for controlling a charging voltage of a charger using a circulating current according to an embodiment;

FIG. 2 is a view schematically illustrating a process of generating a circulating current according to an embodiment;

FIG. 3 is a view illustrating an example of a vehicle charging system in which charge and discharge are performed according to an embodiment;

FIG. 4 is a view illustrating a relay and a controller for controlling the operation of a multi-phase circuit according to an embodiment;

FIG. 5 is a view illustrating a circulating current according to an embodiment;

FIG. 6 is a view illustrating an equivalent circuit converted based on a switching operation according to an embodiment;

FIG. 7 is a view illustrating discharge of a voltage due to a circulating current according to an embodiment; and

FIG. 8 is a view illustrating a configuration of a system for controlling a charging voltage of a charger using a circulating current according to an embodiment.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, embodiments are described in detail with reference to the accompanying drawings.

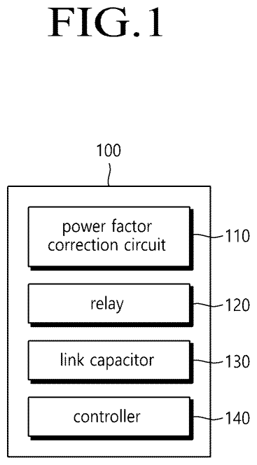

FIG. 1 is a view illustrating a configuration of a device for controlling a charging voltage of a charger using a circulating current according to an embodiment.

Referring to FIG. 1, a device 100 for controlling a charging voltage of a charger using a circulating current generated by a circuit included in a charging device includes a power factor correction circuit 110 for converting a multi-phase AC voltage into a DC voltage based on the operation of a plurality of switching elements.

Power used in electric vehicles is mainly generated from DC voltage. However, the voltage introduced during the charging process may be an AC voltage. As such, a process for converting the AC voltage into the DC voltage is required. The DC voltage remains constant in magnitude and direction over time, but the AC voltage varies. Therefore, direct current is more stable than alternating current. The power factor correction circuit may serve as a converter capable of changing an AC voltage of a high voltage to a DC voltage.

The power factor correction circuit 100 of the disclosure may include a three-phase four-wire circuit including four capacitors, four inductors, and eight switching elements.

The three-phase four-wire circuit includes a U-phase circuit, a V-phase circuit, a W-phase circuit, and a neutral line circuit. In the charging voltage control device of the disclosure, a circuit capable of discharging a voltage without an additional circuit is the above-described three-phase four-wire circuit, and each of the U-phase circuit, the V-phase circuit, and the W-phase circuit may include one capacitor, an inductor, and two switching elements, and the neutral line circuit may include two switching elements.

The neutral line in the neutral line circuit is a component of the circuit, and unlike the ground line where no current flows when it is in the normal state, the neutral line may have a current flow even when it is in the normal state.

The charging voltage control device 100 of the disclosure may generate a circulating current by controlling each component, and may allow at least one passive element to consume the power generated based on the circulating current to thereby discharge the charged voltage.

The power factor correction circuit 110 of the disclosure may include a U-phase circuit, a V-phase circuit, a W-phase circuit, and a neutral line circuit. The U-phase circuit may include a first inductor, a first switching element and a second switching element connected in parallel to the first inductor, and a first capacitor connected between the U-phase circuit and the neutral line circuit. The V-phase circuit may include a second inductor, a third switching element and a fourth switching element connected in parallel to the second inductor, and a second capacitor connected between the V-phase circuit and the neutral line circuit. The W-phase circuit may include a third inductor, a fifth switching element and a sixth switching element connected in parallel to the third inductor, and a third capacitor connected between the W-phase circuit and the neutral line circuit. The neutral line circuit may include a seventh switching element and an eighth switching element.

The device 100 for controlling the charging voltage of the charger using the circulating current generated by the circuit included in the charging device may include a relay 120 including at least one switch connected to the power factor correction circuit 110 to control the current applied to each phase and the neutral line.

The relay 120 may include a switch for controlling current applied to each phase and neutral line. The ON/OFF of the switch may be changed based on a signal received from the controller.

The charging voltage control device 100 of the disclosure may generate a circulating current by changing the switch turning on the U-phase and the V-phase and turning off the remaining switches when discharged.

However, turning on the switch connecting the U-phase and the V-phase described above is merely an example, and the disclosure is not limited thereto. If necessary, the switch connecting the U-phase and the W-phase may be turned on, or the switch connecting the V-phase and the W-phase may be turned on.

The device 100 for controlling the charging voltage of the charger using the circulating current generated by the circuit included in the charging device includes a link capacitor 130 to which the DC voltage converted by the power factor correction circuit is applied.

In the disclosure, the circuit including the link capacitor 130 and the power factor correction circuit 110 including the U-phase circuit, the V-phase circuit, the W-phase circuit, and the neutral line circuit may be referred to as an interleaved buck-boost converter.

The device 100 for controlling the charging voltage of the charger using the circulating current generated by the circuit included in the charging device includes a controller 140 that, when it is required to discharge the link capacitor 130, controls the operation of at least one switch and a plurality of switching elements to generate two or more circulating currents and controls the circulation direction of the two or more circulating currents to discharge the DC voltage through the power generated based on the circulation direction of the two or more circulating currents.

The controller 140, which is a component of the charging voltage control device 100 of the disclosure, may control to turn on the eighth switching element and turn on the switch connecting the U-phase circuit and the V-phase circuit included in the relay 120 to discharge the DC voltage.

The controller 140, which is a component of the charging voltage control device 100 of the disclosure, may control to turn on any one of the first switching element and the second switching element included in the U-phase circuit, turn on any one of the third switching element and the fourth switching element included in the V-phase circuit, turn off the fifth switching element and the sixth switching element included in the W-phase circuit, and turn on the eighth switching element included in the neutral line circuit to discharge the DC voltage.

In the disclosure, the neutral line circuit may be referred to as an N-phase circuit, and the eighth switching element may be referred to as an N-phase lower switching element. The charging voltage control device of the disclosure may include an equivalent circuit based on two circulating currents that controls the switch connecting the U-phase circuit and the V-phase circuit to be turned on and controls the eighth switching element included in the neutral line circuit to be turned on.

For example, two or more circulating currents generated in the charging voltage control device 100 of the disclosure may have the same magnitude.

The controller 140, which is a component of the charging voltage control device 100 of the disclosure, may perform control so that the circulation direction of the first circulation current included in the two or more circulation currents is opposite to the circulation direction of the second circulation current.

In the disclosure, when the circulation direction of the first circulation current and the circulation direction of the second circulation current are opposite to each other, it means that the direction in which the inductor current of the U-phase circuit flows and the direction in which the inductor current of the V-phase circuit flows are opposite to each other.

The DC voltage applied to the link capacitor 130 which is a component of the charging voltage control device 100 of the disclosure may be discharged based on power generated based on circulation of the first circulating current and the second circulating current being consumed through at least one impedance included in the power factor correction circuit 110.

The charging voltage control device 100 of the disclosure may include a passive element including at least one of a resistor, an impedance, an inductor, a capacitor, a relay, and a switching element as an element consuming power or electrical energy. However, the passive element consuming power or electrical energy is merely an example, and is not limited thereto, and may include various passive elements as necessary.

The device 100 for controlling the charging voltage of the charger using the circulating current generated in the circuit included in the charging device may include a DC converter for adjusting the magnitude of voltage between the link capacitor and the battery in the power factor correction circuit 110, the relay 120, the capacitor 130, and the controller 140 described above.

The charging voltage control device 100 of the disclosure may implement the operation of consuming the power generated based on the circulating current generated inside the inverter through software, thereby discharging the charged voltage. Thus, it is capable of quick discharge in terms of being capable of controlling the magnitude and direction of circulating current, thereby preventing a risk of fire that may occur due to charge of a high voltage.

Further, the charging voltage control device 100 of the disclosure may forcibly generate a large circulating current by controlling the magnitude of the circulating current to the system limit value, thereby leading to rapid forced discharge.

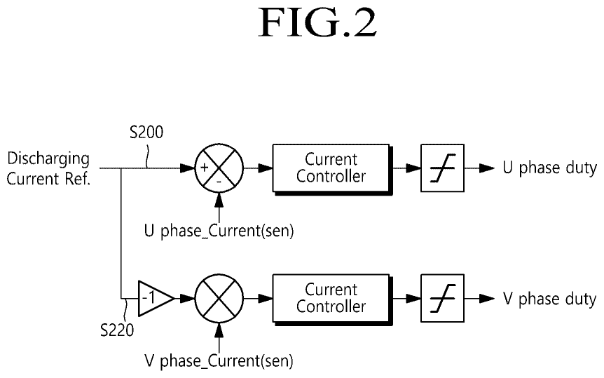

Hereinafter, a process of controlling a voltage of a charging device using a circulating current is described in detail with reference to FIG. 2.

FIG. 2 is a view schematically illustrating a process of generating a circulating current according to an embodiment.

Referring to FIG. 2, the circulating current may be generated through ON/OFF control of the switching element included in the power factor correction circuit.

There is proposed a scheme in which to discharge the DC voltage applied to the link capacitor, the charging current control device of the disclosure generates circulating currents based on the operation of the switching element included in the power factor correction circuit including a multi-phase circuit and control to make the generated circulating currents have the same magnitude and different directions.

For example, the power factor correction circuit of the disclosure may include a three-phase, four-wire circuit including a neutral line circuit. The three-phase circuit includes a U-phase circuit, a V-phase circuit, and a W-phase circuit.

Referring to FIG. 2, a control signal (discharging current reference or discharging current Ref.) for ON/OFF of the switching element may be transmitted from the controller to the power factor correction circuit.

For example, the circulating current may be generated as the signal for operating the switching element for discharging the voltage applied to the link capacitor is transmitted from the controller to the U-phase circuit included in the power factor correction circuit (S200). The ON/OFF operation may be repeated in each of the two switching elements included in the U-phase circuit based on the signal received by the U-phase circuit. Further, the received signal may include the content of determining the magnitude and direction of the circulating current. For example, the circulating current generated in the U-phase circuit may be a current having a clockwise direction of 10A magnitude as the circulation direction. The switching element may include a transistor or a field effect transistor (FET).

As another example, a circulating current may be generated as a signal for voltage discharge is transmitted from the controller to the V-phase circuit included in the power factor correction circuit (S210). The ON/OFF operation may be repeated in each of the two switching elements included in the V-phase circuit based on the signal received by the V-phase circuit. Further, the received signal may include the content of determining the magnitude and direction of the circulating current. For example, the circulating current generated in the V-phase circuit may be a current having a counterclockwise direction of 10A magnitude as the circulation direction.

The circulating current generated in the U-phase circuit and the circulating current generated in the V-phase circuit may be controlled by one controller. The circulating currents may be generated simultaneously or at different times.

However, it is proposed that both the circulation circuits are controlled to have the same magnitude and to flow in opposite directions in order to discharge the voltage charged in the link capacitor.

As circulating currents are generated in the circuits of at least two phases and the directions of the generated circulating currents are controlled through control of the controller, the generated power may be consumed through at least one passive element included in the power factor correction circuit, so that the charged voltage may be discharged.

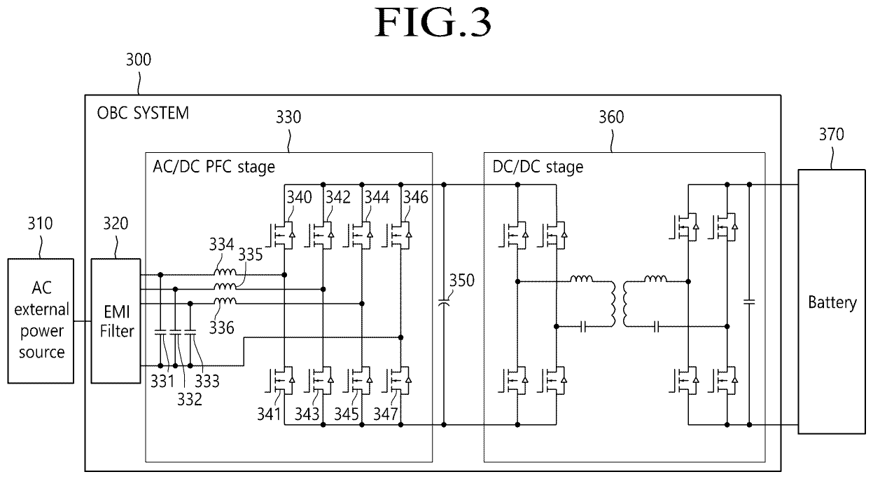

FIG. 3 is a view illustrating an example of a vehicle charging system in which charge and discharge are performed according to an embodiment.

A vehicle charging device that performs charging and discharging through a battery for a vehicle may generally include an inverter that converts an AC voltage into a DC voltage through an external power source, a link capacitor that stores the charged voltage, and a converter capable of controlling the magnitude of the DC voltage.

Referring to FIG. 3, the charging voltage control device 300 of the disclosure may perform charging through an external power source or discharging to consume the charged voltage as necessary. Charging and discharging of the voltage may be performed simultaneously, or only one of charging and discharging may be performed.

Referring to FIG. 3, charging or discharging is performed through the AC external power source 310, the charger 300, and the battery 370.

The charging of voltage in the vehicle may be performed by a process in which voltage is transferred to the charger 300 through the AC external power source 310 and voltage is transferred from the charger 300 to the battery 370. The discharging of the voltage may be performed by transferring the voltage from the battery 370 to the charger 300 or consuming the voltage stored by the charger 300 itself, without involvement of an AC external power source.

Specifically, an AC voltage may be provided to the vehicle through the AC external power source 310. The power supplied to the vehicle is not limited to an AC external power source that provides an AC current, but may be supplied directly from a separate DC power source device.

The charger 300 may include a power factor correction circuit (AC/DC PFC stage) 330 and a link capacitor 350. However, the disclosure is not limited thereto, and an EMI filter 320 and a DC/DC stage 360 may be included.

The power factor correction circuit 330 may convert the AC voltage input through the AC external power source 300 into a DC voltage so as to be used in the vehicle. The circuit included in the power factor correction circuit 330 may be a three-phase, four-wire circuit. The three-phase, four-wire circuit may include a U-phase circuit, a V-phase circuit, a W-phase circuit, and a neutral line circuit, and each of the U-phase circuit, the V-phase circuit, and the W-phase circuit may include at least one capacitor, inductor, and switching element. The capacitors, inductors, and switching elements may be arranged in series or in parallel as necessary.

More specifically, the U-phase circuit may include a first capacitor 331, a first inductor 334, a first switching element 340, and a second switching element 341, the V-phase circuit may include a second capacitor 332, a second inductor 335, a third switching element 342, and a fourth switching element 343, the W-phase circuit may include a third capacitor 333, a third inductor 336, a fifth switching element 344, and a sixth switching element 345, and the neutral line circuit may include a seventh switching element 346 and an eighth switching element 347.

In the disclosure, the first switching element 340 and the second switching element 341 may be referred to as a first leg, the third switching element 342 and the fourth switching element 343 may be referred to as a second leg, the fifth switching element 344 and the sixth switching element 345 may be referred to as a third leg, and the seventh switching element 346 and the eighth switching element 347 may be referred to as a fourth leg.

Further, the respective capacitors included in the U-phase circuit, the V-phase circuit, and the W-phase circuit may be disposed in parallel, the respective inductors may be disposed in parallel, and the respective switching elements may be disposed in parallel.

As described above, the switching element included in each circuit may include a transistor or a FET transistor, and a current may be generated due to the ON/OFF operation of each switching element through the control of the controller.

The EMI filter 320 is a device for removing electrical noise and supplying normal power to the device. Or, the EMI filter 320 means a device that removes electromagnetic contexts disturbing power supply and prevents interruption or malfunction of the system due to disturbance. The EMI filter 320 serves to control in the middle so that interference does not occur between different devices supplying power.

In the disclosure, the EMI filter 320, the power factor correction circuit 330, and the link capacitor 350 altogether may be referred to as an on board charger (OBC) system, or the EMI filter 320, the power factor correction circuit 330, the link capacitor 350, and the DC converter 360 altogether may be referred to as an OBC system.

There is proposed a scheme in which the charging voltage control device of the disclosure discharges the voltage applied to the link capacitor 350 by generating a circulating current by operating some of the three-phase, four-wire circuits.

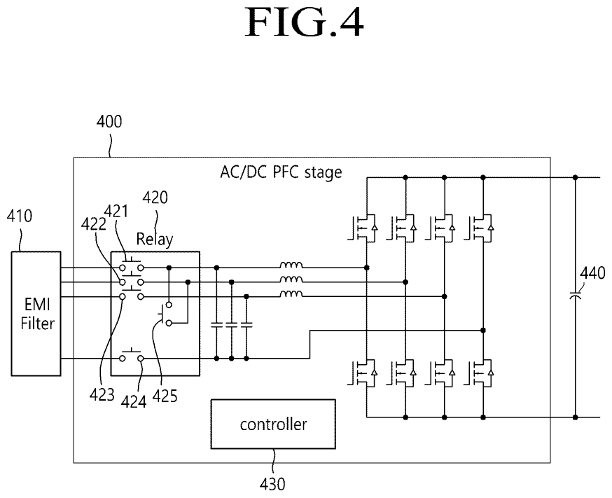

In FIG. 4, a relay including a switch for operating some of three-phase circuits and a controller for controlling the switch and the switching element are described.

FIG. 4 is a view illustrating a relay and a controller for controlling the operation of a multi-phase circuit according to an embodiment.

Referring to FIG. 4, the relay 420 is positioned between the EMI filter and the power factor correction circuit. The relay 420 may control the flow of current applied to each phase. In other words, the relay 420 is a device that opens and closes the circuit based on information such as the presence or absence of current, direction, etc. The relay 420 may include at least one switch. Each switch included in the relay 420 may be turned on or off based on a signal received from the controller 430.

For example, in the power factor correction circuit included in the charging voltage control device 400 of the disclosure according to FIG. 3, the relay 420 may be positioned between the EMI filter and the power factor correction circuit. For example, the first switch 421 may cut off the flow of current applied to the U-phase circuit, the second switch 422 may cut off the flow of current applied to the V-phase circuit, the third switch 423 may cut off the flow of current applied to the W-phase circuit, and the fourth switch 424 may cut off the flow of current applied to the neutral point circuit. Further, the fifth switch 425 may connect or disconnect the U-phase circuit and the V-phase circuit.

In the charging process, the controller 430 of the charging voltage control device 400 of the disclosure may control the first switch 421, the second switch 422, the third switch 423, and the fourth switch 424 to be turned on, and the fifth switch 425 to be turned off.

Further, in the discharging process, the controller 430 may control the first switch 421, the second switch 422, the third switch 423, and the fourth switch 424 to be turned off and only the fifth switch 425 to be turned on in order to block the inflow of AC voltage. However, the ON/OFF of each switch is not limited thereto, and may be variously set according to a method of charging and discharging.

The controller 430 may control ON/OFF of each switch included in the relay 420 and each switching element included in the power factor correction circuit.

For example, the controller 430 may control the fifth switch 425 to be turned on, and may control the first switch 421, the second switch 422, the third switch 423, and the fourth switch 424 to be turned off, thereby generating a circulating current on each phase.

As another example, the controller 430 may repeat the process of turning on the first switching element of the first leg included in the U-phase circuit and turning off the second switching element and, after a predetermined time elapses, turning off the first switching element and turning on the second switching element, thereby generating one circulating current on the U-phase.

As another example, the controller 430 may repeat the process of turning on the third switching element of the second leg included in the V-phase circuit and turning off the fourth switching element and, after a predetermined time elapses, turning off the third switching element and turning on the fourth switching element, thereby generating one circulating current on the V-phase.

As described above, the charging voltage control device of the disclosure may generate a circulating current in each of the U-phase circuit and the V-phase circuit through control of at least one switch included in the relay 420 and at least one switching element included in the power factor correction circuit through the controller 430, consume power generated through circulation of the circulating current in the U-phase circuit and the V-phase circuit through at least one passive element, thereby discharging the voltage charged in the link capacitor 440 and hence protecting the safety of the vehicle and the driver.

Further, the passive element consuming the power generated through the circulation of the circulating current may include at least one of a resistor, a capacitor, and an inductor.

Alternatively, the relay or switching element may also be included in the passive elements that consume power. In the disclosure, the passive element may be referred to as an impedance.

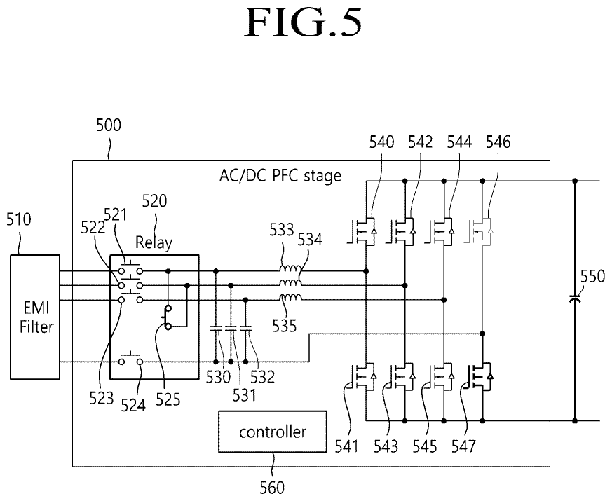

FIG. 5 is a view illustrating a circulating current according to an embodiment.

Referring to FIG. 5, the controller 560 of the disclosure may generate a circulating current by controlling a switch and a switching element, thereby discharging the voltage charged in the link capacitor 550.

For example, the controller 560 may control the fifth switch 525 to be turned on to connect the U-phase circuit and the V-phase circuit, and may control all other switches included in the relay 520 except for the fifth switch to be turned off. Further, the first switching element 540 and the second switching element 541 may be controlled to be turned on or off, the third switching element 542 and the fourth switching element 543 may be controlled to be turned on or off, the seventh switching element 546 may be controlled to be turned off, and the eighth switching element 547 may be controlled to be turned on.

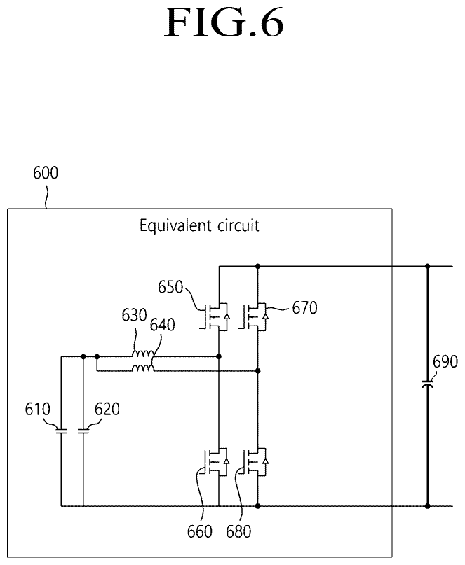

As the controller 560 of the disclosure controls only the fifth switch to be turned on, the drawing of FIG. 5 may be an equivalent circuit to the drawing of FIG. 6.

For example, the first switching element 540 and the second switching element 541 may be repeatedly turned on or off, and one circulating current may be generated in the U-phase circuit through the voltage charged in the link capacitor 550. In the disclosure, this may be referred to as a first circulating current.

As another example, the third switching element 542 and the fourth switching element 543 may be repeatedly turned on or off, and one circulating current may be generated in the V-phase circuit through the voltage charged in the link capacitor 550. In the disclosure, this may be referred to as a second circulating current.

The controller 560 of the charging voltage control device of the disclosure may discharge the voltage charged in the link capacitor by controlling the magnitude and direction of the first circulating current circulated in the U-phase circuit and the second circulating current circulated in the V-phase circuit.

FIG. 6 is a view illustrating an equivalent circuit converted through control of a controller according to an embodiment.

Referring to FIG. 6, the circuit of FIG. 6 illustrates an equivalent circuit converted from the circuit of FIG. 5 based on the operation of the switch controlled by the controller of the disclosure.

The controller of the disclosure may control the fifth switch connecting the U-phase circuit and the V-phase circuit to be turned on, thereby connecting the first capacitor 610 included in the U-phase circuit and the second capacitor 620 included in the V-phase circuit in parallel, connecting the first inductor 630 included in the U-phase circuit and the second inductor 640 included in the V-phase circuit in parallel, or connecting the first leg including the first switching element 650 and the second switching element 660 included in the U-phase circuit and the second leg including the third switching element 670 and the fourth switching element 680 included in the V-phase circuit in parallel.

As described above, the controller of the disclosure may control a first circuit to be generated in the U-phase circuit through the control of the first switching element 650 and the second switching element 660 included in the first leg, and control a second circuit to be generated in the V-phase circuit through the control of the third switching element 670 and the fourth switching element 680 included in the second leg.

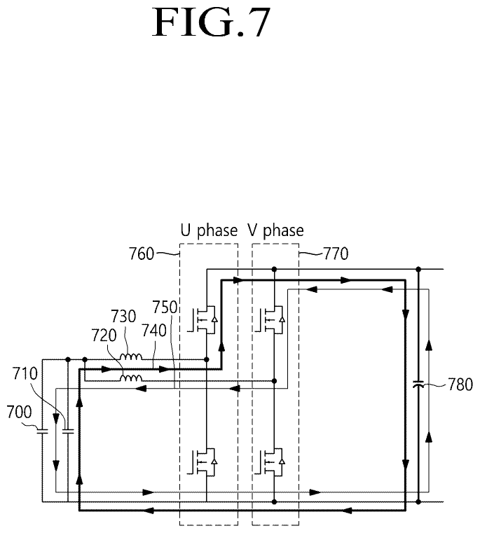

FIG. 7 is a view illustrating discharge of a voltage due to a circulating current according to an embodiment.

Referring to FIG. 7, the charging voltage control device of the disclosure may generate a first circulating current 740 and a second circulating current 750 in each of the U-phase circuit and the V-phase circuit through control of a switch and a switching element through a controller.

Further, the controller of the disclosure may control the magnitude and direction of the first circulating current 740 and the second circulating current 750. Specifically, in the disclosure, in order to safely discharge the voltage stored in the link capacitor 780, control may be performed so that the magnitude of the first circulation current and the magnitude of the second circulation current are the same, and the direction in which the first circulation current 740 flows and the direction in which the second circulation current 750 flows are opposite to each other.

As an example, the controller of the disclosure may perform control so that the circulation direction of the first circulation current 740 is a clockwise direction, and the circulation direction of the second circulation current 750 is a counterclockwise direction.

As another example, control may be performed so that the circulation direction of the first circulation current 740 is a counterclockwise direction while the circulation direction of the second circulation current 750 is a clockwise direction.

If the controller 780 of the disclosure performs control so that the circulation direction of the first circulation current 740 and the circulation direction of the second circulation current 750 are the same direction, and thus, two currents flow to the link capacitor 780 in the same direction, too much current may flow to the link capacitor 780, causing the link capacitor 780 to overheat.

Therefore, there is proposed a scheme in which the charging voltage control device of the disclosure performs control so that the first circulating current and the second circulating current have the same magnitude but have opposite circulation directions to safely discharge the link capacitor in which the high voltage is charged. Accordingly, the charging voltage control device of the disclosure may perform control so that the sum of the input/output currents in the U-phase circuit and the V-phase circuit is zero.

The first circulating current and the second circulating current may flow simultaneously in each circuit. Power may be generated in the power factor correction circuit due to the circulating current. The generated power may be consumed through a passive element.

The passive element of the disclosure may be a resistor, a capacitor, or an inductor. However, the disclosure is not limited thereto, and various means capable of consuming power may be set.

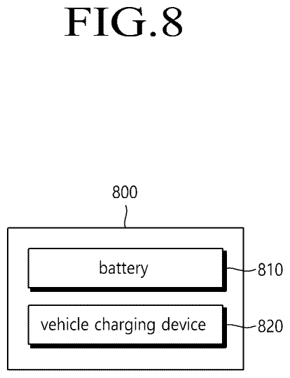

FIG. 8 is a view illustrating a configuration of a system for controlling a charging voltage of a charger using a circulating current according to an embodiment.

Referring to FIG. 8, a system 800 for controlling a charging voltage of a charger using a circulating current generated by a circuit included in a charging device may include at least one battery 810 of FIG. 1 configured in a vehicle.

Further, the system 800 for controlling the charging voltage of the charger using the circulating current generated by the circuit included in the charging device may include a vehicle charging voltage control device 820 for charging a battery.

For example, a vehicle charging voltage control device 820 included in a charging voltage control system 800 may include a power factor correction circuit converting a multi-phase AC voltage into a DC voltage based on an operation of a plurality of switching elements, a relay including at least one switch connected to the power factor correction circuit to control a current applied to each phase and a neutral line, a link capacitor to which a DC voltage converted by the power factor correction circuit is applied, and a controller generating two or more circulating currents by controlling the operation of the plurality of switching elements and the at least one switch when the link capacitor is required to be discharged and controlling circulation directions of the two or more circulating currents to discharge the DC voltage through power generated based on the circulation directions of the two or more circulating currents.

As another example, the power factor correction circuit included in the charging voltage control system 800 of the disclosure may be a three-phase, four-wire circuit including four capacitors, four inductors, and eight switching elements.

As another example, the power factor correction circuit included in the charging voltage control system 800 of the disclosure may include a U-phase circuit, a V-phase circuit, a W-phase circuit, and a neutral line circuit. The U-phase circuit may include a first inductor, a first switching element and a second switching element connected in parallel to the first inductor, and a first capacitor connected between the U-phase circuit and the neutral line circuit. The V-phase circuit may include a second inductor, a third switching element and a fourth switching element connected in parallel to the second inductor, and a second capacitor connected between the V-phase circuit and the neutral line circuit. The W-phase circuit may include a third inductor, a fifth switching element and a sixth switching element connected in parallel to the third inductor, and a third capacitor connected between the W-phase circuit and the neutral line circuit. The neutral line circuit may include a seventh switching element and an eighth switching element.

As another example, the controller included in the charging voltage control system 800 of the disclosure may turn on the eighth switching element and turn on the switch connecting the U-phase circuit and the V-phase circuit included in the relay to control to discharge the DC voltage.

As another example, the controller included in the charging voltage control system 800 of the disclosure may perform control so that the circulation direction of the first circulating current included in two or more circulating currents is opposite to the circulation direction of the second circulating current.

Through the operation of the components included in the above-described system, the voltage charged in the link capacitor may be quickly discharged, and it may be implemented only in software to be adapted to various situations without installing an additional circuit.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. A charging voltage control device, comprising:
a power factor correction circuit converting a multi-phase alternating current (AC) voltage into a direct current (DC) voltage based on an operation of a plurality of switching elements;
a relay including at least one switch connected to the power factor correction circuit to control a current applied to each phase and a neutral line;
a link capacitor to which a DC voltage converted by the power factor correction circuit is applied; and
a controller generating two or more circulating currents by controlling the operation of the plurality of switching elements and the at least one switch when the link capacitor is required to be discharged and controlling circulation directions of the two or more circulating currents to discharge the DC voltage through power generated based on the circulation directions of the two or more circulating currents.

2. The charging voltage control device of claim 1, further comprising a DC converter adjusting a magnitude of a voltage between the link capacitor and a battery.

3. The charging voltage control device of claim 1, wherein the power factor correction circuit is a three-phase, four-wire circuit including four capacitors, four inductors, and eight switching elements.

4. The charging voltage control device of claim 3, wherein the power factor correction circuit includes a U-phase circuit, a V-phase circuit, a W-phase circuit, and a neutral line circuit,
wherein the U-phase circuit includes a first inductor, a first switching element and a second switching element connected in parallel with the first inductor, and a first capacitor connected between the U-phase circuit and the neutral line circuit,
wherein the V-phase circuit includes a second inductor, a third switching element and a fourth switching element connected in parallel with the second inductor, and a second capacitor connected between the V-phase circuit and the neutral line circuit,
wherein the W-phase circuit includes a third inductor, a fifth switching element and a sixth switching element connected in parallel with the third inductor, and a third capacitor connected between the W-phase circuit and the neutral line circuit, and
wherein the neutral line circuit includes a seventh switching element and an eighth switching element.

5. The charging voltage control device of claim 4, wherein the controller controls to discharge the DC voltage by turning on the eighth switching element and turning on a switch connecting the U-phase circuit and the V-phase circuit included in the relay.

6. The charging voltage control device of claim 4, wherein the controller controls to discharge the DC voltage by turning on any one of the first switching element and the second switching element included in the U-phase circuit, turning on any one of the third switching element and the fourth switching element included in the V-phase circuit, turning on the fifth switching element and the sixth switching element included in the W-phase circuit, and turning on the eighth switching element included in the neutral line circuit.

7. The charging voltage control device of claim 1, wherein the two or more circulating currents have the same magnitude.

8. The charging voltage control device of claim 1, wherein the controller performs control so that a circulation direction of the first circulating current included in the two or more circulating currents is opposite to a circulation direction of the second circulating current.

9. The charging voltage control device of claim 1, wherein the DC voltage applied to the link capacitor is discharged based on power generated based on circulation of the first circulating current and the second circulating current being consumed through at least one impedance included in the power factor correction circuit.

10. A charging voltage control system, comprising:
at least one battery configured in a vehicle; and
a vehicle charging voltage control device for charging the battery,
wherein the vehicle charging voltage control device includes:
a power factor correction circuit converting a multi-phase AC voltage into a DC voltage based on an operation of a plurality of switching elements;
a relay including at least one switch connected to the power factor correction circuit to control a current applied to each phase and a neutral line;
a link capacitor to which a DC voltage converted by the power factor correction circuit is applied; and
a controller generating two or more circulating currents by controlling the operation of the plurality of switching elements and the at least one switch when the link capacitor is required to be discharged and controlling circulation directions of the two or more circulating currents to discharge the DC voltage through power generated based on the circulation directions of the two or more circulating currents.

11. The charging voltage control system of claim 10, wherein the power factor correction circuit is a three-phase, four-wire circuit including four capacitors, four inductors, and eight switching elements.

12. The charging voltage control system of claim 11, wherein the power factor correction circuit includes a U-phase circuit, a V-phase circuit, a W-phase circuit, and a neutral line circuit,
wherein the U-phase circuit includes a first inductor, a first switching element and a second switching element connected in parallel with the first inductor, and a first capacitor connected between the U-phase circuit and the neutral line circuit,
wherein the V-phase circuit includes a second inductor, a third switching element and a fourth switching element connected in parallel with the second inductor, and a second capacitor connected between the V-phase circuit and the neutral line circuit,
wherein the W-phase circuit includes a third inductor, a fifth switching element and a sixth switching element connected in parallel with the third inductor, and a third capacitor connected between the W-phase circuit and the neutral line circuit, and
wherein the neutral line circuit includes a seventh switching element and an eighth switching element.

13. The charging voltage control system of claim 12, wherein the controller controls to discharge the DC voltage by turning on the eighth switching element and turning on a switch connecting the U-phase circuit and the V-phase circuit included in the relay.

14. The charging voltage control system of claim 10, wherein the controller performs control so that a circulation direction of the first circulating current included in the two or more circulating currents is opposite to a circulation direction of the second circulating current.
